(19) United States
(12) Patent Application Publication
(10) Pub. No.: US 2006/0236321 A1
(43) Pub. Date: Oct. 19, 2006

(54) Clock-timer that displays a web page after a timing period

(76) Inventor: Kenneth Roy Thornton-Smith, Rockledge, FL (US)

Correspondence Address: Ken Thornton-Smith, 1032 Marlin Dr, Rockledge, FL, 32955, US

(21) Appl. No.: 11/105,853

(22) Filed: Apr. 14, 2005

(51) Int. Cl. G06F 9/46

(52) U.S. Cl. 718/102

(57) ABSTRACT

This may be a process, method and computer clock-timer that displays a web page after a timing period, the process having steps of: a computer clock-timer or clock-timer feature that takes the form of a clock-timer, a separate list of URLs containing one or more URLs, a timing period, and where the computer clock-timer opens a URL from the list at the end of each timing period.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of computers and more specifically to computer systems that display web pages.

The Internet and its better-known sibling, the World Wide Web, are driven by the addresses of individual web pages. A web page is simply a file, and its address is the filename. This address is known as the Universal Resource Locator, or URL. A typical address would be: http://news.bbc.co.uk/, where the first element stands for Hypertext Transfer Protocol, and the next is the website which includes the website type, and in this example, the country of origin. Implicit in this home address URL is the suffix address of the homepage: index.html.

Typically, web pages on the Internet are examined by means of a browser, which can display any web page given its URL. The browser is a specialised form of computer program designed to display web pages.

To display a web page, the user will follow a URL link from another web page or type in the URL of a particular web page. Very often, the user will have no idea of the existence of a web page, let alone its URL. In that case, the user will use a search engine to find web pages related to their area of interest.

The Internet currently consists of over 10 billion web pages, each of which can be addressed by its URL. This represents a huge information resource. Unfortunately, the Internet is not arranged by content, and especially is not organised into areas of interest. To make things more complicated, a specific website will often contain pages relating to several different subjects.

The problem of finding a web page related to the user's particular interest can be formidable. Search engines remain the greatest ally, but a search on many subjects can easily return over a million web pages. That is considerably less than 10 billion, but nevertheless would require extraordinary dedication to comprehensively sort and investigate such a huge quantity of information.

Many web sites are commercial enterprises that rely on users visiting their website to attract business. Partly as a result of the great difficulty in finding web pages, businesses have resorted to some annoying practices to attract visitors. These include spam or UCE (Unsolicited Commercial Email), pop-ups, pop-unders, and various information-gathering programs. At best these are irritating and unethical, in some instances and some jurisdictions they are illegal.

There currently exists no simple method to solicit, attract and embrace special interest groups. Commercial attempts to attract website visitors have largely alienated computer users. For instance, a user visiting a website about fishing is quite likely to be confronted with a pop-up banner advertising home equity loans; another user might visit a site related to amateur radio only to find a window containing an advertisement for medicine.

The future prospects of Web commerce have arguably been damaged by these irritating business practices. Although it is gradually being addressed, the Internet currently exhibits a lack of focus or targeted marketing practices that would not be acceptable in any other advertising environment. The only reason they exist on the Internet is the very low cost of Internet marketing which allows very low conversion rates to be effective.

### BRIEF SUMMARY OF THE INVENTION

A primary object of the invention is to provide a convenient method for a computer user to be introduced to web sites of interest.

Another object of the invention is to provide such a method in a manner where the user can optionally exercise control over the subject matter.

Another object of the invention is to provide such a method in a manner where the user can optionally exercise control over the displayed web pages.

Another object of the invention is to provide a method of targeting website visits by interested users.

Yet another object of the invention is to provide such a method in a manner where the user can optionally exercise control over the timing of the web page display.

Other objects and advantages of the present invention will become apparent from the following descriptions, taken in connection with the accompanying drawings, wherein, by way of illustration and example, an embodiment of the present invention is disclosed.

The clock-timer herein behaves rather in the manner of an alarm clock, where the user can preset a particular time of day, or set for a particular timing interval.

For the purposes of this document, a “timing period” is defined as any length of time ending in a timing event. The timing period may be delimited as determined by the user; or it may be an absolute time or it may be a timing interval. The timing period and the subsequent timing event may be random or may be selected by any other means.

In accordance with a preferred embodiment of the invention, there is disclosed a process or method that optionally opens a window displaying a web page after a timing period, wherein a clock-timer decides upon a particular URL by any means, and wherein at the end of a timing period the clock-timer uses an existing window or opens a new window and displays the web page corresponding to the URL.

In accordance with an alternate embodiment of the invention, the clock-timer is embedded or working in conjunction with another application in the manner of a plug-in or browser extension or other variation that optionally opens a window displaying a web page at the end of a timing period, wherein the clock-timer decides upon a particular URL by any means, and wherein at the end of a timing period the clock-timer uses an existing window or opens a new window and displays the web page corresponding to the URL.

This clock-timer invention can be a method of automatic selection of web sites of interest, comprising: establishing a user-selected criteria from the group consisting of subject matter, web page or pages to be displayed, timing of web page display, a URL list, and combinations thereof; and using a clock-timer to select a particular URL based on said criteria and displaying the web page corresponding to the URL.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

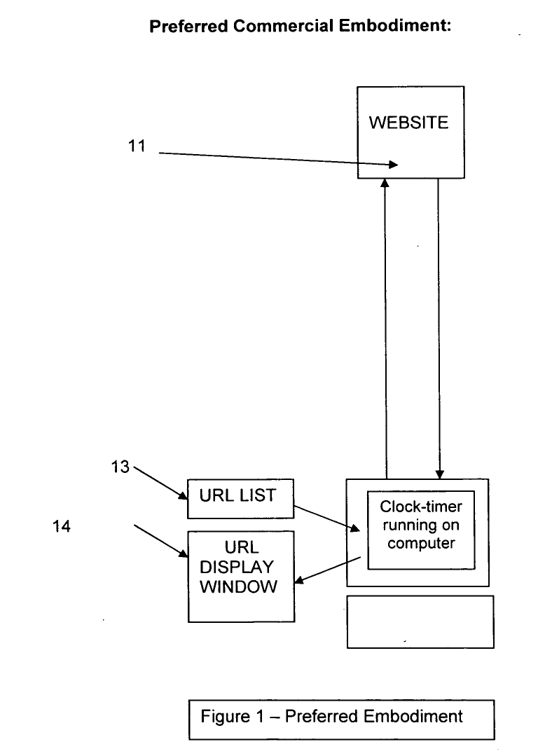

FIG. 1 is a schematic block diagram of the clock-timer in a preferred embodiment comprising the following steps:
a website or webpage (11) is constructed that typically relates to a specific subject of interest;
wherein from any source but typically from said specific interest webpage a user would download a clock-timer;
wherein the said system would be installed (12) on their computer;
wherein a timing period is selected by any means;
wherein the clock-timer decides upon a particular URL by any means but typically would select the URL from a list of special interest URLs (13);
wherein the URL may be stored locally or other location and
wherein at the end of the timing period the clock-timer optionally uses an existing window or opens a new window (14) and displays the web page corresponding to the URL.

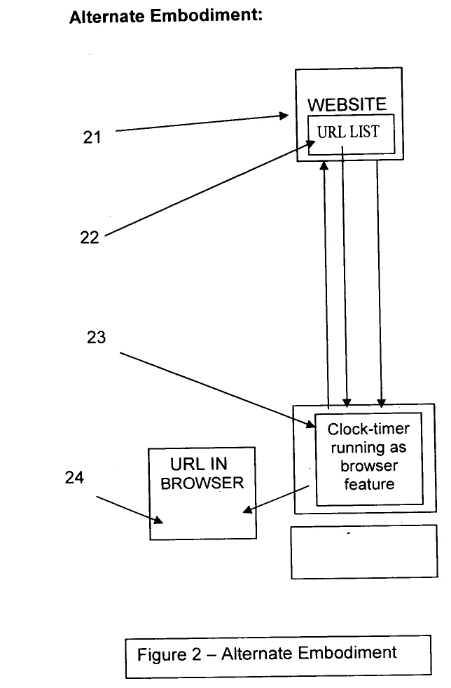

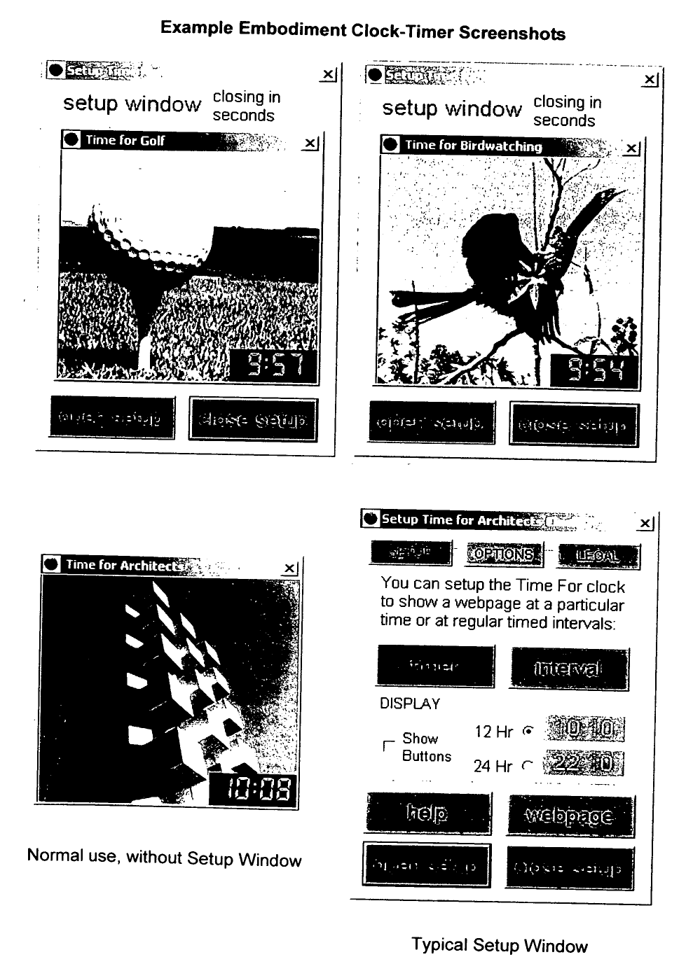

FIG. 2 is a schematic block diagram of the clock-timer in an alternate embodiment comprising the following steps:
a website or webpage (21) is constructed that typically relates to a specific user-group interest;
wherein from any source but typically from said specific interest web site a user would download a clock-timer, or a complete application containing said clock-timer;
wherein the said clock-timer might be a feature or subcomponent of another system;
wherein the said clock-timer would be installed to work internally as a feature or subcomponent or in conjunction with an existing application such as a browser in the manner of a plug in or browser extension or other means (23);
wherein a timing period is selected by any means;
wherein the clock-timer decides upon a URL by any means, but typically would select from a URL list (22);
wherein the URL list may be stored locally or on a website or other location;
wherein upon completion of the timing period the clock-timer uses an existing window or opens a new window in the host application (24) and
wherein the clock-timer module optionally displays the web page corresponding to the URL.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turning first to FIG. 1 there is shown in diagram form a computer and a website. The computer requests a specific web page by sending the URL. The web page corresponding to the URL is returned and displayed by the computer. This is normally handled by a particular kind of computer program known as a browser. While this existing system works admirably, there are problems not addressed by the prevailing technology. In particular, computer users have great difficulty in finding relevant web sites, and commercial web sites resort to irritating business practices in order to attract visitors.

This invention can comprise a clock-timer (12) capable of displaying in an existing window or opening a new window or browser and displaying a web page at the end of a timing period. In this embodiment there is an associated URL list (13). The user may optionally visit a web page from the URL list by clicking a button or by another clock-timer event such as the end of a timing period. The clock-timer selects the URL and at the end of the timing period or other event the clock-timer displays the web page corresponding to the URL.

Obviously, using a traditional browser, a computer user can type in a URL and visit a web page when he or she desires, but this is a very laborious process. This invention describes a new method of automating the process in a manner that requires the minimum of user intervention. This new invention addresses the Internet introduction process in an innovative manner and as a result connects highly targeted computer users to relevant websites.

Turning again to FIG. 1, in this embodiment the URL list (13) consists of one or more pre-selected URLs each related in some way to the computer user's special interest. The URL list may be stored where convenient, and the clock-timer may select one or more URLs using a selection method such as sequential or random or by any other means. The URL may also be sent to the clock-timer from an external source. Further special-interest URLs or URL lists would be available. In this way the computer user may determine the subject matter of the displayed web pages.

The computer user may invoke the optional timer feature of the clock-timer to display a web page by setting a timing period, or may use a button or other event to visit a web page on this or any other URL list. In this manner the computer user can determine when web pages of interest are displayed.

Returning to FIG. 1, the URL window (14) can optionally display one of the URLs on the list. The display window may optionally contain buttons such as “next” and “previous” and “random” and allow the user to navigate other URL lists or further web pages of interest from any source.

Using this new invention, the computer user now has control over the subject matter of the web page and control over when it is displayed in a manner that is not currently available. In this new invention the selection and display of web pages take place automatically by invoking the timing features inherent in the clock-timer.

The new features embodied in this invention are therefore the automation of which subject matter web pages are displayed and when they are displayed. Using the new methods of this invention, the computer user optionally now has control over web page content and display timing. In this way, as described in the new features of this invention, a computer user is displayed only those websites that particularly interest them. The new results addressed by this invention and not previously available are the targeted introduction of specific web pages and interested computer users.

As an example, in a typical implementation a young girl may be interested in ponies. She may go to the web site or web page related to the ponies clock-timer and download and install a clock-timer called “Time for Ponies.” She may set up the clock-timer to display a web page once every hour, or at 4 p.m. every day.

The clock-timer runs and, when the timing period is up, opens a window containing a web page. All the web pages displayed are related to ponies. Some of them may be related to particular types of ponies in which she has no interest, so she deletes them, but the remainder are displayed regularly. Because the web pages are related to her special-interest, she learns more about ponies but at the same time is introduced to related merchandise such as riding gear, feed, medication and tackle.

Using this new invention, the computer user visits websites related to their special interest, and the websites are regularly visited by prequalified computer users.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method of computer selection of web sites of interest, comprising:
establishing a user-selected criteria from the group consisting of subject matter, web page or pages to be displayed, timing of web page display, a URL list, and combinations thereof; and
using a clock-timer to select a URL based on said criteria and displaying a web page corresponding to said selected URL.

2. The method of claim 1, wherein said clock-timer automatically opens a window displaying a web page after a timing period.

3. The method of claim 1, wherein said clock-timer selects a URL from the URL list.

4. The method of claim 1, wherein said clock-timer selects a URL from the URL list after a timing period.

5. The method of claim 1, wherein said clock-timer is enabled by said user.

6. The method of claim 1, wherein said clock-timer is enabled at predetermined intervals.

7. The method of claim 1, wherein said URL list is computer-generated based on user-selected subject matter.

8. The method of claim 1, wherein URLs in said URL list are user-deletable.

9. A method for computer display of a web page at the end of a timing period, comprising:
activating a computer clock-timer, wherein the timing period is determined by any means;
determining a target URL by any means; and
displaying a web page corresponding to said URL at the end of at least one timing period.

10. The method as claimed in 1, wherein the target URL is opened in a new or existing application window native to said clock-timer computer clock-timer or an external application window.

11. A method of displaying a computer web page at the end of a timing period, comprising:
activating a computer clock-timer feature or subcomponent that takes the form of a clock-timer, wherein the clock-timer feature is available inside a computer system, or externally working in conjunction with another computer system;
determining a timing period by any means;
determining a target URL by any means; and
displaying a web page corresponding to the URL at the end of at least one timing period.

12. The method of claim 11 wherein the target URL is opened in a new or existing application window native to the host clock-timer or an external application.
